(19) United States
(12) Patent Application Publication
(10) Pub. No.: US 2010/0131868 A1
(43) Pub. Date: May 27, 2010

(54) LIMITEDLY SHARING APPLICATION WINDOWS IN APPLICATION SHARING SESSIONS

(75) Inventors: Jitendra P. Chawla, Union City, CA (US); Zheng Yuan, San Jose, CA (US)

Correspondence Address: CESARI AND MCKENNA, LLP, 88 BLACK FALCON AVENUE, BOSTON, MA, 02210, US

(73) Assignee: Cisco Technology, Inc., San Jose, CA (US)

(21) Appl. No.: 12/323,903

(22) Filed: Nov. 26, 2008

(51) Int. Cl. G06F 3/048

(52) U.S. Cl. 715/759; 715/760

(57) ABSTRACT

In one embodiment, an application sharing session may be established between a presenter device and one or more viewer devices, and at least one application window may be generated on the presenter device that is to be shared with the one or more viewer devices. At the presenter device, a determination may be made regarding which one or more predefined areas of the application window are to be limitedly shared. Accordingly, the application window may be shared with the one or more viewer devices, while limiting sharing of the one or more predefined areas of the application window.

### TECHNICAL FIELD

The present disclosure relates generally to computer networks, and, more particularly, to collaborative computing sessions.

### BACKGROUND

Collaborative computing sessions, such as interactive conferences (e.g., “web” or “online” conferences/meetings), may be supported by a network of servers and client computers. In particular, one feature available to online meetings or data conferencing systems is to allow computer users at different locations to communicate via a computer network and share applications stored and/or executed on one of the users computers, such as through a software program that enables the users to share applications (e.g., sharing a presenter's application with one or more attendees/viewers). Techniques for sharing applications during a data conference may comprise sharing a predefined area of the presenter's computer screen with an attendee (e.g., “desktop sharing”), where the presenter's computer captures an image within a predefined portion of the presenter's computer screen/display (e.g., the entire screen or a portion of the screen), which is then transmitted to the attendee's computer for viewing. Also, a refinement to this conventional technique allows the presenter to selectively share application windows with the attendee (e.g., “application sharing”). Thus, non-shared application windows placed within the predefined portion of the presenter's computer screen may be hidden from the attendees. In either sharing technique, attendees/viewers may also be able to control or provide input to the applications executing on the presenter's computer.

For example, as part of providing customer service, a customer service representative may need to look at a customer's view of a web-site (an example application window) to help the customer complete a transaction, such as filling forms, completing financial transactions, make reservations, etc. Generally with sharing sessions, however, all of the presenter's application window (or desktop) is shown to the attendees/viewers, regardless of the information's sensitivity, security, or other reasons for not sharing the information. Thus, the customer service representative (or any other attendee/viewer in any sharing session) may be shown or may be able to control various aspects of the presenter's application window that are undesirably (or unnecessarily) shared.

### BRIEF DESCRIPTION OF THE DRAWINGS

The embodiments described herein may be better understood by referring to the following description in conjunction with the accompanying drawings in which like reference numerals indicate identically or functionally similar elements, of which:

FIG. 1 illustrates an example computer network;

FIG. 2 illustrates an example participant device;

FIG. 3 illustrates an example interaction server;

FIG. 4 illustrates an example computer network for application sharing;

FIG. 5A illustrates an example presenter device display with application sharing;

FIG. 5B illustrates an example attendee/viewer device display with application sharing;

FIG. 6 illustrates an example procedure for application sharing;

FIG. 7A illustrates an example presenter device display of an application window;

FIG. 7B illustrates an example viewer device display of an application window; and

FIG. 8 illustrates an example procedure for limitedly sharing areas of application windows in an application sharing session.

### DESCRIPTION OF EXAMPLE EMBODIMENTS

### Overview

According to embodiments of the disclosure, an application sharing session may be established between a presenter device and one or more viewer devices, and at least one application window may be generated on the presenter device that is to be shared with the one or more viewer devices. At the presenter device, a determination may be made regarding which one or more predefined areas of the application window are to be limitedly shared. Accordingly, the application window may be shared with the one or more viewer devices, while limiting sharing of the one or more predefined areas of the application window. For example, the areas to be limitedly shared (e.g., hidden or restricted) may comprise secure information or presenter-only controlled areas.

### Description

Architecture for Collaborative Computing Sessions

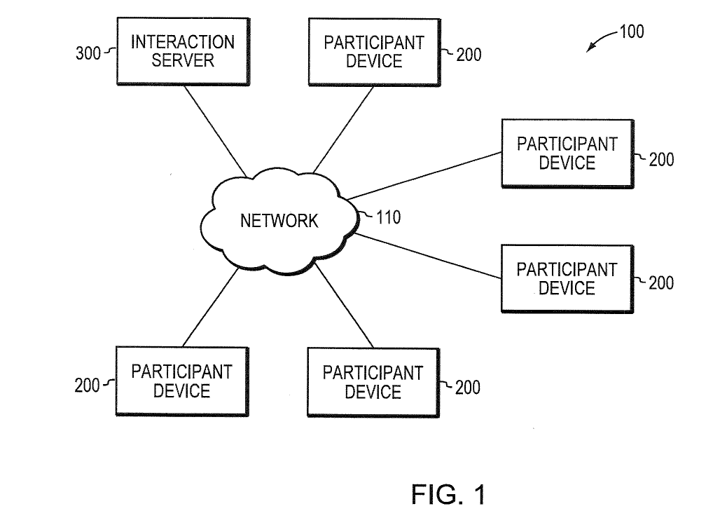

FIG. 1 is a schematic block diagram of an example computer network 100 illustratively comprising nodes/devices, such as one or more participant devices 200 and one or more interaction servers 300 interconnected by links/network 110 as shown and as described further herein. For instance, participant devices, as described below, may be a personal computer (PC) or one or more peripheral devices, such as phones, pagers, etc. Those skilled in the art will understand that any number of nodes, devices, links, etc. may be used in the computer network, and that the view shown herein is for simplicity.

In this environment, a number of participants may interact in an on-line, interactive, or collaborative setting. Such a setting can be for a meeting, training or education, support, or any other event that may require a number of participants to work together, interact, collaborate, or otherwise participate, such as web conferences, on-line meetings, etc. As used herein, the phrase “collaborative computing session” may be used to describe these settings/events, particularly where a number of participant computers/devices collaborate in an established session, as may be appreciated by those skilled in the art. Also, as used herein, a “session” describes a generally lasting communication between one or more participant devices 200 through the interaction server 300. Those skilled in the art will understand that the session may be implemented/established using protocols and services provided by various layers (e.g., application, session, and/or transport layers) of a network protocol stack according to the well-known OSI model. Conversely, a “meeting” describes a personal layer of communication overlaid upon the session where participants/users communicate with each other. Moreover, while the terms “session” and “meeting” may generally be used interchangeably herein to denote a collaboration of people or devices, particular instances of their use may denote a particular distinction (e.g., a session may start with attendees joining/connecting to the servers, while a meeting may not start until a host/presenter joins the session), as may be understood by those skilled in the art.

In other words, a collaboration session comprises a plurality of devices or “participant devices,” of which “attendee devices” are configured to view/receive content submitted or “shared” by “presenter devices.” In some instances, the attendee devices are capable of modifying the content shared by the presenter device (e.g., described below).

In particular, each participant (e.g., hosts/presenters and/or attendees) may operate a participant device 200. Each participant device 200 may comprise an electronic device with capability for visual and/or auditory presentation. Thus, a participant device 200 can be, for example, a desktop personal computer (PC), a laptop computer, a workstation, a personal digital assistant (PDA), a wireless telephone, a smart phone, an Internet television, and the like. Each participant device 200 supports communication by a respective participant, in the form of suitable input device (e.g., keyboard, mouse, stylus, keypad, etc.) and output device (e.g., monitor, display, speech, voice, or other device supporting the presentation of audible/visual information). Each participant device may be interconnected with a suitable communications network 110 such as, for example, the Internet, and may appear as a client computer thereon.

In one embodiment, each participant device 200 may operate under the control of a suitable operating system (OS) (e.g., WINDOWS, UNIX, etc.) to run software applications (e.g., in the form of code modules) which may be installed, received, or downloaded. At least some of these software applications may support specific functions, such as, for example, functions related to the on-line, interactive meeting (a collaborative computing session), such as conventional web browser programs that allow convenient access and navigation of the Internet (e.g., the World Wide Web).

The on-line meeting (collaborative computing session) of the various participants may be supported by an interaction server 300 which may be maintained or operated by one or more of the participants and/or a third-party service provider. The interaction server 300 may be a computer system that is connected to network 110, and which may comprise and appear as one or more server computers thereon. Interaction server 300 may store information (e.g., content) and application modules which can be provided to the participant devices 200. In some embodiments, these application modules are downloadable to the participant devices 200 and may support various functions that may be required for an interactive meeting or collaborative effort among the participants. The participant devices 200 and the interaction server 300 may interact in a client/server architecture, which may provide high performance and security for a multi-participant collaborative environment.

Network 110 may comprise or be supported by one or more suitable communication networks, such as, for example, a telecommunications network that allows communication via one or more telecommunications lines/channels. In particular, the communication or data networks, such as the Internet, may be used to deliver content, such as for the collaborative computing sessions herein. The Internet is an interconnection of computer clients and servers located throughout the world and exchanging information according to Transmission Control Protocol/Internet Protocol (TCP/IP), Internetwork Packet eXchange/Sequence Packet eXchange (IPX/SPX), AppleTalk, or other suitable protocol. The Internet supports the distributed application known as the “World Wide Web.” Web servers maintain websites, each comprising one or more web pages at which information is made available for viewing and audio/hearing. Each website or web page may be supported by documents formatted in any suitable conventional markup language (e.g., HTML or XML). Information may be communicated from a web server to a client using a suitable protocol, such as, for example, Hypertext Transfer Protocol (HTTP) or File Transfer Protocol (FTP).

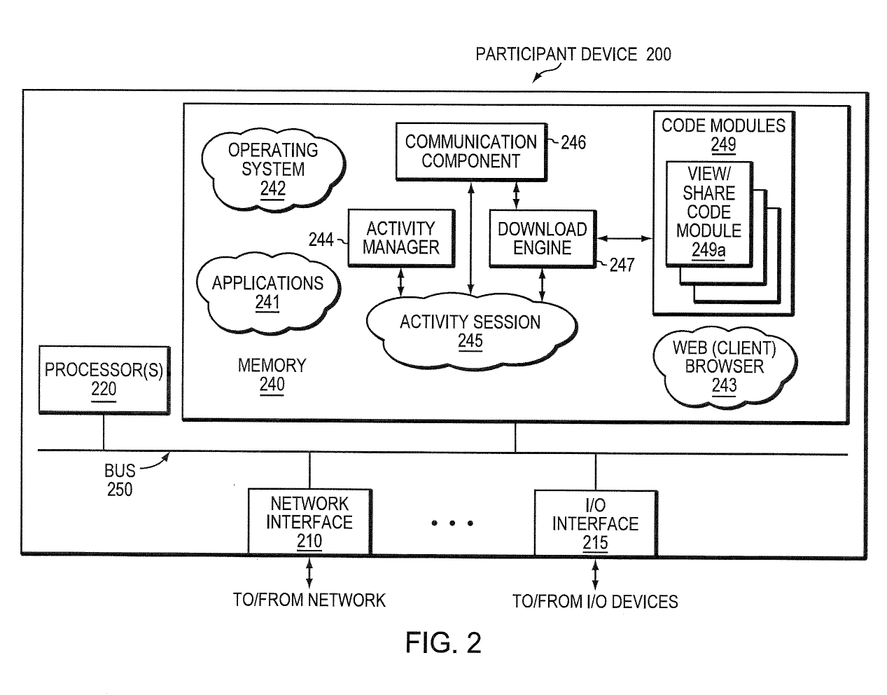

FIG. 2 illustrates a schematic block diagram of an example participant device 200 that may be advantageously used with one or more embodiments described herein, e.g., for collaborative computing. Illustratively, device 200 may be implemented or incorporated in any suitable computer such as, for example, a personal computer (PC), laptop, workstation, personal digital assistant (PDA), smart phone, mainframe, file server, workstation, or other suitable data processing facility supported by storage (either internal, e.g., electronic memory, or external, e.g., magnetic/optical disk), and operating under the control of any suitable OS.

In particular, the device 200 comprises one or more network interfaces 210, one or more input/output (I/O) interfaces 215, one or more processors 220, and a memory 240 interconnected by a system bus 250. The network interfaces 210 contain the mechanical, electrical, and signaling circuitry for communicating data over physical/wireless links coupled to the network 110. The network interface(s) may be configured to transmit and/or receive data using a variety of different communication protocols suitable for the network. Also, I/O interfaces 215 contain the mechanical, electrical, and signaling circuitry for communicating with one or more user interface devices, such as a mouse, keyboard, monitor/screen, etc. (not explicitly shown).

The memory 240 comprises a plurality of storage locations that are addressable by the processor(s) 220 and the network interfaces 210 for storing software programs associated with the embodiments described herein. A portion of the memory may (though need not) be arranged as a cache (not shown) configured to store one or more data structures and/or code modules 249 associated with the embodiments described herein. The processor(s) 220 may comprise necessary elements or logic adapted to execute the software programs and manipulate the data structures. An operating system 242, portions of which are typically resident in memory 240 and executed by the processor(s), functionally organizes the device by, inter alia, invoking operations in support of software processes and/or services executing on the device (e.g., for collaborative computing sessions as used herein). In particular, these software processes and/or services may comprise one or more applications 241, and, in particular, an activity manager 244, a communications component 246, a download engine 247, and an activity session 245. It will be apparent to those skilled in the art that other types of processors and memory, including various computer-readable media, may be used to store and execute program instructions pertaining to the inventive technique described herein, such as a web browser 243, known in the art. Also, activity manager 244, communications component 246, code modules 249, download engine 247, and/or activity session 245 may be operated as instances of suitable programs running on the hardware of a participant device 200, as will be further appreciated by those skilled in the art.

Activity manager 244 may contain computer executable instructions executed by each processor 220 to generally perform functions to manage or control various processes or aspects during the course of an activity (e.g., on-line meeting or collaborative computing session) in which the participant (user) may interact with other users. As shown in FIG. 2, this activity may be run in activity session 245. In the context of on-line meetings, for example, the activity manager 244 may manage meeting-related actions (e.g., starting a session, ending a session, locking a session, etc.), manage participant-related actions (e.g., designating a participant as a session host, assigning a participant the presenter privileges, expelling a participant, establishing participant privileges, etc.), manage session-related actions (e.g., starting a sharing session, closing a sharing session, setting privileges within that sharing session, etc.), and support an interface with the user or participant, and provide a container for embedding one or more application code modules.

A communications component 246 supports communication between system 200 and an outside network 110 (e.g., the Internet), such as through network interfaces 210. Communications component 246 thus allows data and information to be exchanged with or retrieved from other systems or facilities (e.g., participant devices 200 or interaction server 300), for example, during an online meeting or other collaborative computing session. In particular, the communications component 246 may provide a communication platform for any one or more of the activity manager 244, the activity session 245, the download engine 247, and the application code modules 249. The activity manager 244 may rely on the communications component 246 to establish and maintain the client connection to the interaction server 300 on which the activity session is hosted. Each application code module 249 may also use the established client connection to provide realtime data that is sent and received by each participant.

Various functionality for supporting a collaborative computing session, such as an on-line meeting, may be provided by the one or more application code modules 249. These application code modules 249 may be stored/maintained (e.g., by a cache), and may support, for example, basic communication framework, file sharing (e.g., for text, images, video, audio), user authentication, meeting scheduling, address book, files and folders, invoices, billing, scheduling, telephone or video conferencing, authentication, database management, word processing, application sharing, accounting, etc. For example, code modules may comprise (not specifically shown) a text-based chat module, a polling module, a video module, a voice over Internet Protocol (VOIP) module, a question-answer (QA) module, a file transfer module, a presentation module, an application/desktop view/share module, and an Internet telephony module. Also, one or more of the application code modules 249 may be dynamic linked library (DLL or “.dll”) executable object code files.

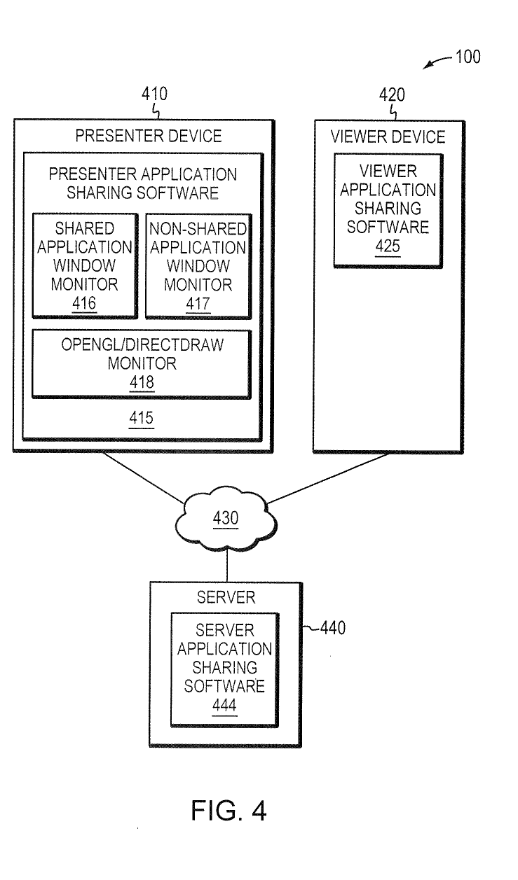

Illustratively, in accordance with one or more embodiments described herein, the application/desktop viewing/sharing module (shown as 249a) may provide functionality that allows participants to share single applications, multiple applications, or the entire desktop (as understood by those skilled in the art). For the participant who is a presenter, the application viewing/sharing module may maintain a list of currently running processes that are located at the user level of the local machine. The application viewing/sharing module 249a may allow selection of one or more participants with which to share the content of those running processes. In one embodiment, e.g., through a complex kernel driver or screen capturing technology, the application viewing/sharing module 249a captures Graphics Device Interface (GDI) calls made from the applications to the system, convert and encode the data, and unicast the data to the other participants via the interaction server 300. For each participant that receives the data, the application viewing/sharing module 249a may decode the data and display the content. The viewing/sharing module may allow or enable participants to join or exit a session of application sharing, share or not share an application, set sharing privileges, enter or leave annotations, provide a full screen view of shared information, and get information to be shared. (Further details of application viewing/sharing module 249a may be found below with reference to the techniques of one or more embodiments described herein. For example, see FIG. 4 below.)

In addition, the video and/or VOIP modules (not explicitly shown) may provide real-time video and/or voice/audio functionality to each participant to provide different functionality to each participant depending on the status and privileges of that participant. For example, for a participant who is a presenter, the modules may capture the video image from a video input device and/or audio from an audio input device, encode the data, and unicast the data to the other participants through the interaction server 300. For each participant that receives the data, the respective modules may decode the data and display/play the content. Thus, the video module may allow or enable various participant to join or exit a video session, edit video segments, or change a video presenter, while the VOIP module may allow or enable various participants to join or exit a VOIP session, pass the microphone to another participant, or display a volume window or control.

Also, the text-based chat module may provide a real-time text messaging function to each participant, allowing or enabling participants to join or exit an online chat, save or print a portion of the chat messaging, load a chat file, or change the privileges of participants involved in the chat. Also, the polling module and/or QA module may provide real-time polling (or question and answer) functionality to each participant.

Further, the file transfer module may provide functionality for transferring files between and among participants in the session. The functions of the file transfer module vary depending on the status and privileges of each participant. For example, the file transfer module may allow a host/presenter to open any directory accessible from the participant device 200 (local machine) and to post a file pointer in a transfer container. Additionally, a presenter can set file transfer privileges for each participant. Any other participant who has been given privileges to download the file can select the file pointer from the list and save the file to his/her local machine. The file transfer module may allow or enable participants to join or exit a transfer, set permissions for the transfer, transfer the file, and save a file.

Moreover, the presentation module may provide functionality that allows participants to share various printable media types (e.g., document, whiteboard, or facsimile). For the participant who is a presenter, the presentation module can convert the selected media content, encode the data, and unicast the data to the other participants via the interaction server 300 (e.g., in a proprietary format). For the each participant that receives the data, the presentation module may decode the data and display the content. The presentation module may allow or enable participants to open, join, or exit a session of a presentation, save, print, or copy a portion of the presentation, change a presenter, get information about the presentation, add or clear annotations from the presentation, choose a font for the text of presentation, and send the presentation to others via facsimile transmission.

Still further, the telephony module may provide a simple user interface for participating in an interactive, on-line telephony session. The telephony module may allow or enable participants to join or exit a telephony session, place or disconnect from a telephony call, invite someone else to join in a telephony call, mute or un-mute a telephony call, and get information for a telephone number.

Those skilled in the art may appreciate that the code modules and their respective functionalities are merely examples, and a participant device 200 may comprise additional or fewer code modules 249 than those described above. As such, code modules may be added or removed per-functionality in order to support a collaborative computing session, whether those functions are needed or optional, and the specific code modules described herein are not meant to limit the scope of the embodiments described herein.

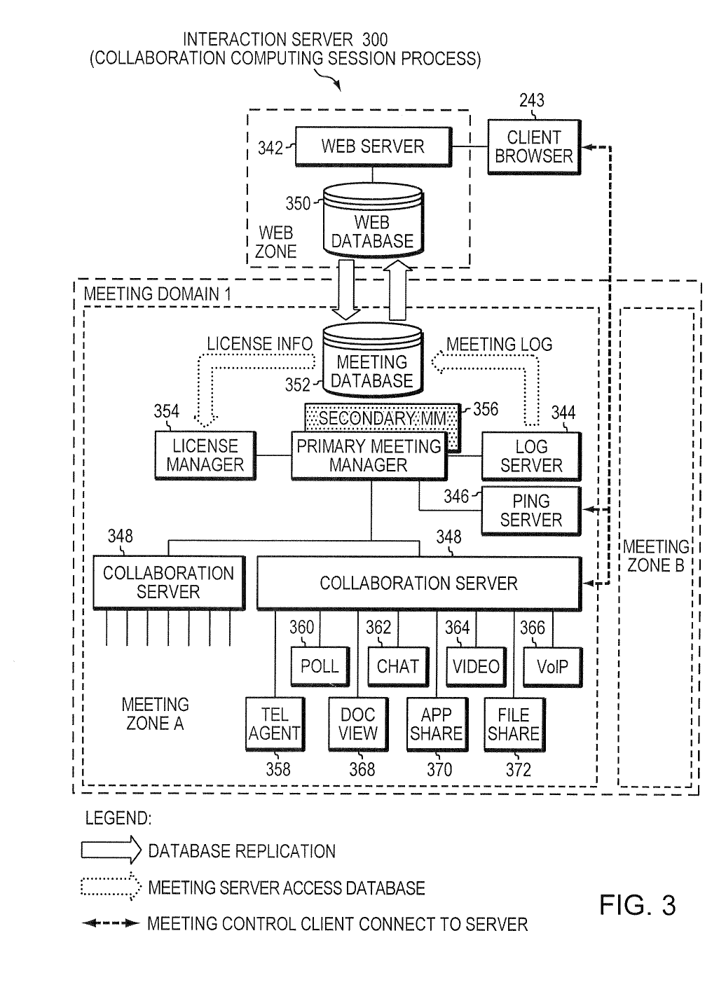

Notably, download engine component 247 may be in communication with activity session component 245, and communications component 246 (e.g., and a cache) to cause various application modules 249 to be downloaded (e.g., automatically) to system 200 under certain circumstances, such as during an initialization process or when the functionality that is supported by such modules is required. Illustratively, the download engine component 247 may be implemented as ActiveX code (ActiveX download engine), Java code (Java download engine), or any other suitable code which may be appropriate for various browser software. (That is, depending on the browser software that the participant is using to access the meeting and depending on browser and system permissions, the appropriate code-version of the download engine component may be invoked.) FIG. 3 illustrates an example implementation for a computer system that may operate as interaction server 300 according to one or more embodiments described herein. Illustratively, in the computer system environment as shown, a number of server computers and databases may be in communication to provide for collaborative meeting or computing. As such, the interaction server 300 and its various components may be referred to as a collaborative computing process 300. (Illustrative details for such a computer system environment may be found in commonly-owned, copending U.S. patent application Ser. No. 09/751,424 entitled “DISTRIBUTED NETWORK SYSTEM ARCHITECTURE FOR COLLABORATIVE COMPUTING,” filed on Dec. 29, 2000, by Zhu et al., now published as U.S. Patent Application Publication 2003/0167301 on Sep. 4, 2003.) Notably, while the illustrative embodiment described below shows a collection of servers (e.g., localized and/or distributed), a single server may also operate to perform the functions described herein (e.g., collaborative computing process 300). Thus, “interaction server 300” may comprise, either as a single server or as a collection of servers, one or more memories, one or more processors, one or more network interfaces (e.g., adapted to communicate traffic for a collaborative computing session and also traffic on a communication channel other than the collaborative computing session), etc., as may be appreciated by those skilled in the art.

In particular, referring to the environment shown in FIG. 3, a number of processing facilities, including, for example, one or more of a web server 342, a log server 344, a ping server 346, a collaboration server 348, license manager 354, primary and secondary meeting managers 356, application servers (e.g. telephone agent 358, poll 360, chat 362, video 364, voice over IP 366, document view 368, application share 370, and file share 372) may be integrated with a number of data storage facilities, such as, for example, a web database 350 and a meeting database 352 to implement a system for collaborative meetings over the Internet (e.g., for collaborative computing session “process” 300). As depicted, the processing and database facilities of this environment (“process” 300) may be divided into a web zone and one or more meeting zones for interaction with one or more client browsers (which may operate on respective participant devices 200).

A web zone may comprise one or more server machines that share a common web database 350. In the web zone, web server 342 may have a unique IP address (which may be associated with a particular website) and may respond to, e.g., Hyper-Text Transport Protocol (HTTP) requests coming to that IP address from client browser 243. Web server 342 serves or supports web pages, while web database 350 may contain static information for the website including site specific data, web pages, and user data.

Illustratively, a meeting zone is a collection of servers and databases that help perform synchronous activity of an on-line collaborative meeting. In a meeting zone, the meeting managers 356 may be servers which communicate with other servers in the meeting zone (e.g., collaboration server 348, log server 344, ping server 346, etc.) to keep track of the on-line meetings in progress in the meeting zone. Meeting managers 356 may log meeting information into meeting database 352. Ping server 346 works with meeting managers 356 to determine a collaboration server 348 that is most suitable for hosting a particular meeting; it may act as a load balancer for the meeting service. Collaboration servers 348 may handle all real time control and communication during an online collaborative meeting. The application servers (e.g., servers 358 through 372) may support specific features that may be available as part of an on-line collaborative meeting, such as, for example, telephony, polling, chatting, video, voice over IP, document review, application sharing, and file sharing. Also, license manager 354 may keep track of and enforce licensing conditions and charges for the meeting. Further, the log server 344 may keep track of meeting logs, and meeting database 352 may maintain at least a portion of the transient data required to conduct and keep track of on-line meetings. This data may include, for example, site and user information that would be required to establish and conduct a meeting.

Application Sharing between Presenter and Attendees/Viewers

Conventional application sharing techniques capture a predefined portion of the presenter's computer screen (e.g., the entire screen or a rectangle within the entire screen) and provide the image within the predefined portion of the presenter's computer screen to the viewer (e.g., “desktop sharing”). All of the applications that have windows positioned within the predefined portion of the presenter's computer screen are captured by the presenter's computer, transmitted to the viewer's computer, and displayed on the viewer's computer screen whether or not the presenter intended to share these appliction windows with the viewer. As a result, the presenter may inadvertently share an application window with a viewer that the presenter does not intend to share with the viewer. By using “application sharing,” however, these disadvantages may be overcome by sharing or not sharing particular application windows as selected by the presenter. For instance, a shared application window refers to a window belonging to an application that a presenter intends to share with a viewer, and the term non-shared application window refers to a window belonging to an application that a presenter does not intend to share with a viewer. (Note that references to a window are directed to an area utilized to display the content, and references to a desktop are directed to an entire portion of a display area of a corresponding device.)

FIG. 4 illustrates an alternative view of network 100 (as shown in FIGS. 1-3) in accordance with application sharing, generally. For instance, code module 249a, application/desktop viewing/sharing, may be (for application viewing/sharing only) represented as further detailed in FIG. 4. That is, code module 249a of a presenter device 410 may comprise presenter application sharing software 415, which may be any type of suitable software that enables presenters and viewers to share applications, documents, or the like. Presenter application sharing software 415 may comprise the following software components: shared application window monitor 416, non-shared application window monitor 417, and OpenGL/DirectDraw monitor 418. The function of each of these software components is discussed in detail below. Presenter application sharing software 415 may also include other software components that are not shown or discussed for clarity.

Viewer device 420 also includes viewer application sharing software 425 (as a detailed embodiment of code module 249a), which can be similar to or the same as presenter application sharing software 415. Viewer application sharing software 425, among other things, receives images of application windows from the presenter's computer and displays the images on the viewer's computer screen. In certain embodiments, viewer application sharing software 425 may also capture and transmit viewer inputs/commands to the shared application executing on the presenter device 410 (e.g., relayed through presenter application sharing software 415), such as for “co-browsing” as described below.

According to application sharing, a presenter may select which particular applications/windows to share with the one or more attendees/viewers of a collaboration session. The presenter's device (e.g., presenter application sharing software 415) may then transmit shared applications to the viewer's device (e.g., to viewer application sharing software 425) over network 430, with non-shared applications not transmitted, and overlapping regions (where the non-shared applications cover the shared applications) being blocked from transmission. (Notably, while the techniques described herein reference presenter application sharing software 415 as operating to control the sharing/non-sharing of application windows, the server application sharing software 444 of server 440/300 may instead be configured to receive all viewable content from the presenter, and to limit the transmission of non-shared or covered shared application windows, accordingly.)

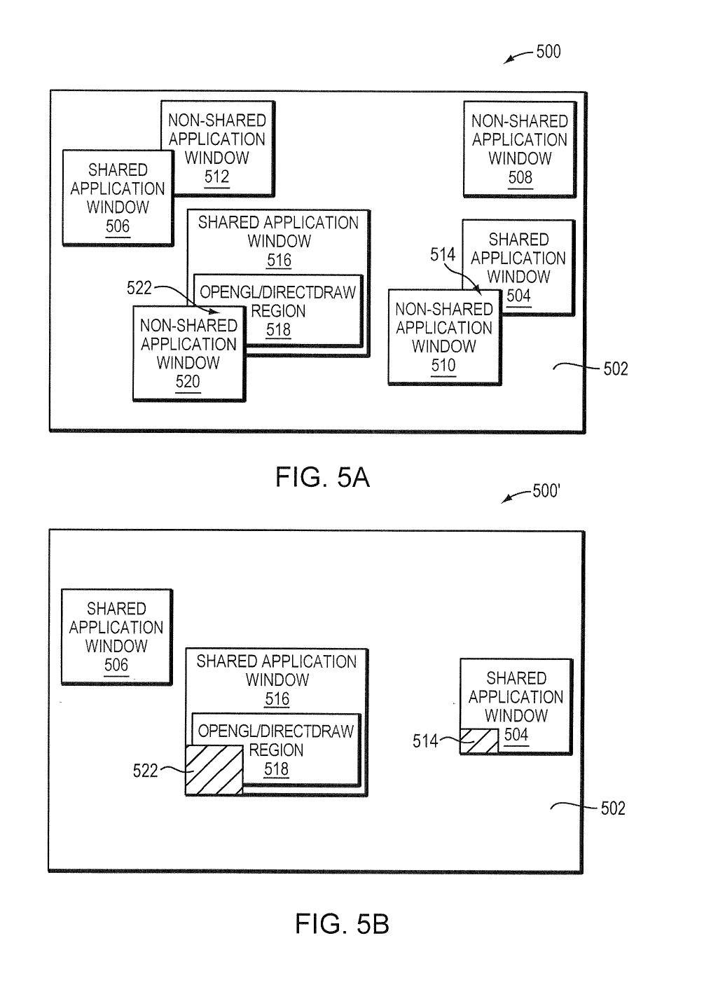

Illustratively, FIGS. 5A and 5B show an example of how application sharing (e.g., application-based screen sampling) may operate, e.g., during a data conference. FIG. 5A shows a presenter's computer screen 500 having background region 502, shared application windows 504 and 506, non-shared application windows 508, 510, and 512, and overlapping region 514. In addition, shared application window 516 may include an OpenGL/DirectDraw region 518, which is a region drawn by OpenGL/DirectDraw (respectively). The region of shared application window 516 outside of region 518 is referred to as the non-OpenGL/DirectDraw region, which is a region that is not drawn by OpenGL/DirectDraw. Non-shared application window 520 overlaps shared application window 516 at overlapping region 522.

Based on application sharing, therefore, FIG. 5B shows a viewer's computer screen 500′, which has background region 502′, shared application windows 504′, 506′, and 516′, and overlapping regions 514′ and 522′. In particular, a portion of application window 506′ is obscured by overlapping region 514′, and a portion of OpenGL/DirectDraw region 518′ and non-OpenGL/DirectDraw region 518′ of shared application window 516′ is obscured by overlapping region 522′.

For example, to create FIGS. 5A and 5B, once a sharing session (e.g., data conference) has started, the presenter may select one or more applications to share with a viewer. Presenter application sharing software 415 receives the presenter's selections and then performs application based sharing as follows with reference to FIG. 5.

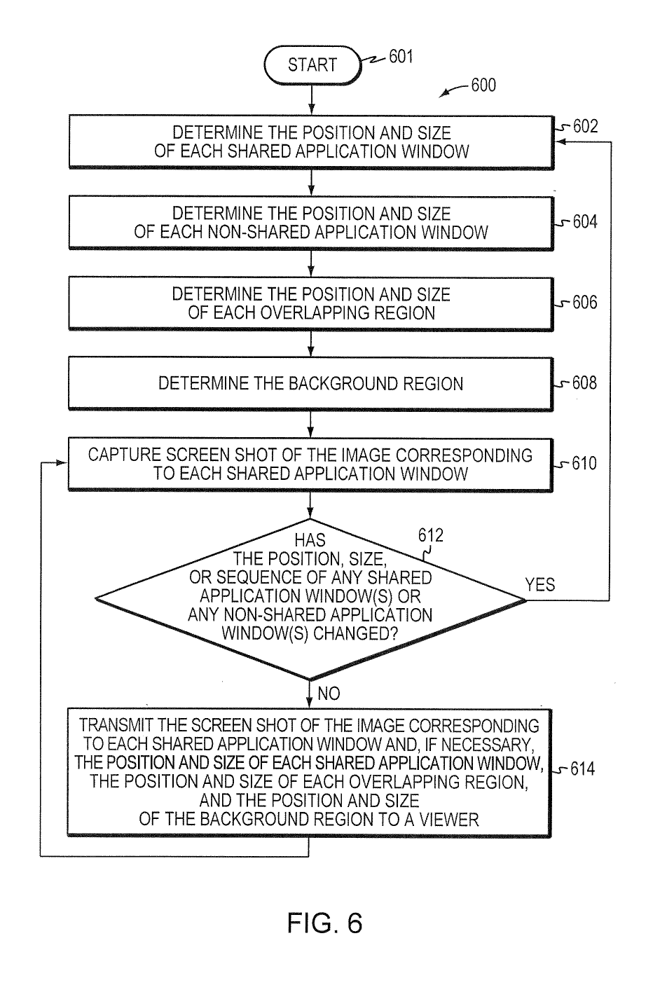

In particular, FIG. 6 is a flowchart of an example procedure 600 for application-based screen sampling, according to one or more embodiments herein. (Procedure 600 assumes that the presenter has pre-defined or pre-designated an application as a shared application during the data conference, as mentioned above.) Procedure 600 begins in step 601, and continues to step 602, where the position and the size of each shared application window is determined, e.g., by shared application window monitor 416. If the shared application only has one window, the position and size of this window is determined. If the shared application has several windows, the position and size of each of these windows is determined.

The position and size of each shared application window may be determined dynamically by monitoring and intercepting function calls made by the shared application to a graphics display subsystem. For instance, the graphics display subsystem receives the function calls and, in response, causes appropriate graphics or images to be drawn on the presenter's computer screen 500. For example, if the application is running on a Microsoft Windows based computer, the application may call Graphics Device Interface (GDI) functions to draw images on the presenter's computer screen. The function calls provide information that identifies which application a particular window belongs to, the position of the window, and the size of the window. Thus, by monitoring and intercepting the function calls, the position and size of a window can be determined.

Notably, in step 602, the position and the size of each OpenGL and/or DirectDraw regions of a shared application window may also be determined (e.g., by OpenGL/DirectDraw monitor 418). For instance, the OpenGL/DirectDraw regions are the areas within the shared application windows that are drawn by OpenGL/DirectDraw (respectively).

OpenGL is a well-known application program interface (API) that is used by applications to draw graphics (e.g., 2D and 3D graphics) on a presenter's computer screen. To generate graphics using OpenGL, an application first launches OpenGL. The application then calls OpenGL functions. As a result of these function calls, OpenGL internally calls glFlash, glDraw, and/or glEscape, which are OpenGL subsystems. Finally, the glFlash, glDraw, or glEscape subsystems cause the graphics to be drawn on the presenter's computer screen.

The position and size of the OpenGL regions of each shared application window can be determined dynamically by monitoring and intercepting OpenGL function calls made by the application. For example, the position and size of the OpenGL regions of each window belonging to a shared application can be determined dynamically by monitoring and intercepting function calls to the glFlash, glDraw, and glEscape subsystems of OpenGL. Thus, by monitoring and intercepting the function calls made to OpenGL or to the glFlash, glDraw, and/or glEscape subsystems of OpenGL, the position and size of each OpenGL region within a shared application window can be determined.

In addition, DirectDraw is a well-known Windows-based API used to create graphics. Many applications use DirectDraw to draw graphics on a presenter's computer screen. Unlike OpenGL and other general windows APIs, DirectDraw is COM based. To generate graphics using DirectDraw, an application first launches DirectDraw. The application then gets the COM interfaces corresponding to DirectDraw. Next, the application calls the DirectDraw COM interface to access the DirectDraw functions. Finally, the DirectDraw COM interface calls an internal function to render the graphics.

The position and size of each DirectDraw region of each shared application window can be determined by monitoring the DirectDraw COM interface. As mentioned above, DirectDraw is not like OpenGL and other general windows APIs; DirectDraw is COM based. Since Direct Draw is COM based, it is not possible to monitor function calls made by the application directly to DirectDraw to determine the position and size of each DirectDraw region of each shared application window. However, Applicant has discovered that the position and size of each DirectDraw region of each shared application window can be determined by dynamically monitoring the, DirectDraw COM interface and intercepting information that defines the position and size of each DirectDraw region of each shared application window. (It should also be recognized that the procedure may be modified so that any COM interface, not just the DirectDraw COM interface, can be monitored).

In step 604, the position and the size of each non-shared application window is determined, e.g., by non-shared application window monitor 417. If the non-shared application only has one window, the position and size of this window is determined. If the non-shared application has several windows, the position and size of each of these windows is determined. The position and size of each non-shared application window may be determined dynamically by monitoring and intercepting function calls made by the non-shared application to a graphics display subsystem (as described in step 602 above).

In step 606, the position and size of each overlapping region is determined. An overlapping region is a region on the presenter's computer screen where a non-shared application window overlaps a shared application window, such as, e.g., a non-OpenGL region or an OpenGL region of a shared application window or a non-DirectDraw region or a DirectDraw region of a shared application window (generally, “shared application windows” herein). If none of the non-shared application windows overlap shared application windows, there are no overlapping regions. Conversely, if multiple non-shared application windows overlap shared application windows, there are multiple overlapping regions. The position and size of each overlapping region can be determined by comparing the position and size of each shared application window with the position and size of each non-shared application window.

In step 608, the background region is determined, which is the area on the presenter's computer screen that is not occupied by a shared application window. The background region includes areas of the presenter's computer screen that are occupied by non-shared application windows, or not occupied by any application windows. The background region can be determined by comparing the position and size of each shared application window (e.g., non-OpenGL and the OpenGL regions or non-DirectDraw and the DirectDraw regions of each shared application window) with the position and size of the presenter's entire computer screen.

In step 610, a screen shot of the image corresponding to (or “within”) each shared application window is captured so that it can be provided to the viewer. This step may be performed periodically (e.g., five times per second) so that changes to the image on the presenter's computer screen are quickly reflected on the viewer's computer screen. Illustratively, the screen shot of the image corresponding to each shared application window can be captured by capturing portions of the frame buffer on the presenter's computer that correspond to shared application windows. Since step 602 determines the sizes and positions of the shared application windows, the location of the shared application windows within the frame buffer are known.

In step 612, the position, size, and sequence of each shared application window and each non-shared application window is monitored. If the position, size, or sequence of a shared application window or a non-shared application window changes, then procedure 600 returns to step 602. If the position, size, and sequence of the shared application windows and the non-shared application windows do not change, then procedure 600 proceeds to step 614. The position, size, and sequence of each shared application window and each non-shared application window on the presenter's computer screen can be dynamically monitored by monitoring and intercepting function calls made by the shared and non-shared applications to a graphics display subsystem (as described in step 602 above).

In step 614, the screen shot of the image corresponding to each shared application window and, if necessary, the position and size of each shared application window, the position and size of each overlapping region, and the position and size of the background region is transmitted to the viewer's computer, e.g., via server 440 (“server application sharing software” 444). If the position, size, and sequence of the shared application windows and the non-shared application windows have not changed since the previous screen shot was transmitted to the viewer's computer, then the position and size of the shared application windows, the position and size of the overlapping regions, and the position and size of the background region do not have to be retransmitted to the viewer's computer. On the other hand, if the position, size, or sequence of the shared application windows or the non-shared application windows have changed since the previous screen shot was transmitted to the viewer's computer, then the updated position and size of the shared application windows, the updated position and size of the overlapping regions, and/or the updated position and size of the background region are transmitted to the viewer's computer. This ensures that the viewer's computer screen accurately reflects what is currently displayed on the presenter's computer screen. Prior to transmission, the screen shot of the images corresponding to each shared application window can be compressed using image compression techniques such as GZIP or JPEG.

Once the viewer's computer has received the screen shot of the image corresponding to each shared application window, and if transmitted, the position and size of each shared application window, the position and size of each overlapping region, and the position and size of the background region, viewer application sharing software 425 can display the image on the viewer's computer screen 500′. To accomplish this, viewer application software 425 performs the following process. First, viewer application software 425 generates or draws a background region based on the position and size of the background region. The background region can be filled or painted with an arbitrary color or image. Second, viewer application software 425 generates or draws a window corresponding to the position and size of each shared application window. Third, viewer application sharing software 425 generates or draws the image corresponding to each shared application window inside of each shared application window. Fourth, viewer application software 425 generates or draws an overlapping region corresponding to the position and size of each overlapping region. The overlapping region can be filled or painted with an arbitrary color or image.

In addition, viewer application sharing software 425 may detect control/input (e.g., mouse clicks or keyboard entries, etc.) within the shared application window region, and may transfer these controls/inputs to the presenter device via the sharing session for execution on the shared application at the presenter device (e.g., as interpreted and executed by presenter application sharing software). For example, the presenter application may display a text entry field, and the viewer application may insert text into the field (via the sharing session) based on user input at the viewer device. Thus presenter application sharing software 415 may be configured to accept/receive the control/input from the viewer device, and may correspondingly provide the control/input into appropriate locations/fields of the shared application. Those skilled in the art will understand the above details are merely representative examples, and that other application sharing techniques may be used, accordingly.)

Application sharing (application-based screen sampling) thus allows a presenter to define or designate applications as shared applications and non-shared (or “unshared”) applications. Windows belonging to shared applications and non-shared applications are monitored and only windows belonging to shared application windows are displayed on a viewer's computer screen.

As noted above, however, sharing sessions generally share all of the presenter's application window (or desktop) with the attendees/viewers, regardless of the information's sensitivity, security, or other reasons for not sharing the information (with the exception, though, of portions of shared application windows covered by non-shared application windows). Thus, any attendee/viewer in any sharing session may be shown or may be able to control various aspects of the presenter's application window that are undesirably (or unnecessarily) shared. For example, as part of providing customer service, a customer service representative may need to look at a customer's view of a web-site (an example application window) to help the customer complete a transaction, such as filling forms, completing financial transactions, make reservations, etc. It may therefore be desirable to prevent the customer service representative from either taking certain actions (e.g., submit a trade, submit a reservation, etc.) or view certain information/data (e.g., social security numbers, credit card information, etc.) while application sharing (e.g., “co-browsing” with the customer.

Limitedly Sharing Application Windows

According to embodiments of the disclosure, an application sharing session may be established between a presenter device and one or more viewer devices, and at least one application window may be generated on the presenter device that is to be shared with the one or more viewer devices. At the presenter device, a determination may be made regarding which one or more predefined areas of the application window are to be limitedly shared. Accordingly, the application window may be shared with the one or more viewer devices, while limiting sharing of the one or more predefined areas of the application window. For example, the areas to be limitedly shared (e.g., hidden or restricted) may comprise secure information or presenter-only controlled areas.

Illustratively, certain techniques described herein (e.g., the determination and the graying out) may be performed by presenter device 410, such as in accordance with presenter application sharing software 415 (e.g., shared application window monitor 416). In particular, these processes and/or services may be configured to operate in accordance with certain techniques as described herein, such as to limitedly share areas of shared application windows in a shared application session. For example, where the shared application is a web-page or web-site, the shared application session may be referred to as a “co-browsing” session (e.g., web browsing application 243 of a presenter device is shared with one or more viewer devices). Also, as noted, viewer application sharing software 425 may also be configured to receive the shared applications (e.g., images associated therewith) as well as to transfer control/inputs received at the viewer device to the presenter device for execution on the shared application (where applicable).

Operationally, the presenter device 410 may participate in an online collaborative computing session as described in detail above, and in accordance with application sharing, the presenter may select one or more applications to be shared or non-shared (unshared) among attendees of the session. The generated application window(s) (that is/are shared) may be any type of application, such as a word processing application, presentation application, web browser application, etc. In particular, an illustrative web browser application may be used with “co-browsing” sessions, where a web page/site loaded and executing on a presenter device (web browser 243) may be shared with one or more viewer devices to “co-browse” the web page. Note that in accordance with the embodiments herein, any application may be shared in this manner, and the techniques are not limited to co-browsing web pages. In addition, co-browsed web pages are not limited to the web page itself, but also may include any “applets” (e.g., a software component or simple application that runs in the context of another program or as a standalone program, e.g., Java® applets, Flash® movies, etc.) that are generated in conjunction with associated shared applications.

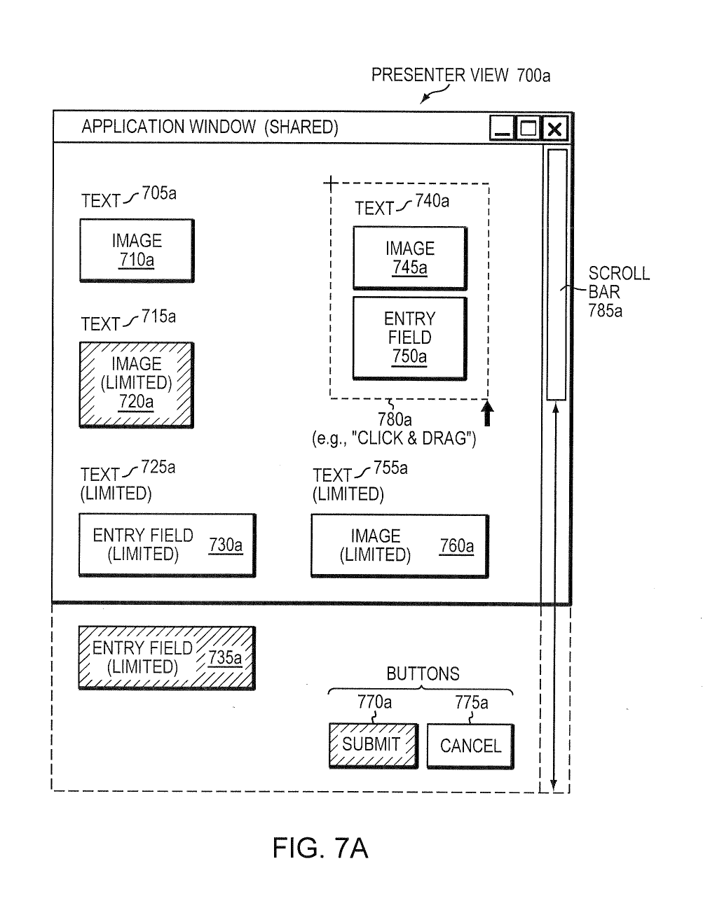

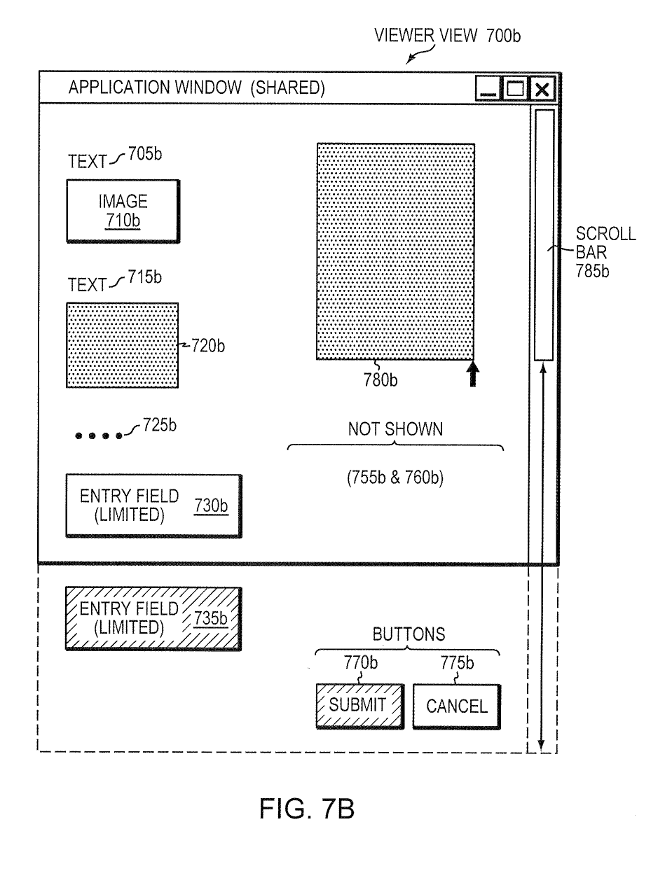

FIGS. 7A and 7B illustrate an example application window (presenter's version 700a, viewer's version 700b) in accordance with the embodiments as described below. In particular, application window 700 (where numbers followed by an “a” imply a presenter's perspective, and numbers followed by a “b” imply a viewer's perspective) may comprise various text fields (e.g., 705, 715, 725, 740, and 755), images (e.g., 710, 720, 745, and 760), entry fields/boxes (e.g., 730, 735, and 750) and buttons (e.g., 770 and 775). Also, as described below, a scroll bar 785 may be present within application window 700. Separate applet windows, in particular, are not explicitly shown, though those skilled in the art will appreciated that an applet window is a type of application window, and thus the same techniques described below may be used with regard to application windows or applet windows, accordingly.

As mentioned above, the presenter device 410 may determine one or more predefined areas of the application window 700a that are to be limitedly shared, such then upon sharing the application window with the one or more viewer devices (window 700b), the sharing of the one or more predefined areas may be limited. Limitedly shared areas may be used by applications (e.g., programmers/administrators of the applications) to provide for content blocking in application sharing (e.g., hiding/covering content for viewers) or selective control in application sharing (e.g., restricting control/input from viewers). “Limitedly sharing,” therefore, may comprise using any suitable technique to convey less-than-full access to an aspect of a presenter device's application window 700a, such as by limiting, restricting, or otherwise not fully sharing a particular area or region of a shared application window 700a as described herein.

For instance, regarding certain applications (e.g., web-sites), a corresponding programmer/administrator (e.g., a company) may wish to define rules that prevent a viewer (e.g., a customer service representative) from performing certain actions or viewing certain content on the application (e.g., web-site) during the application sharing session. For example, applications designed by/for financial services, online travel, online shopping, etc., may define areas of the application window that are able to accept controls and/or input from only the presenter and not any viewer (that is, allowing “presenter-only” control and input). Illustratively, a “submit” button 770 may represent a submit button, an accept button, a buy button, an agree button, etc., each of which may be a selectable option that the designer of application window 700 desired (or was required) to keep in the control of the presenter. Also it may be desirable to prevent a viewer from entering information into certain fields, such as entry field 735. As an example, assume that a financial service web-page may prevent a viewer (e.g., customer service representative) from selecting or “clicking” a submit button on a stock trading page or an online travel service web-page may similarly prevent selection of a reservation acceptance.

In addition, areas of an application window may be defined as containing secure information or other content that is to be limitedly shared from a presenter's device 410 to the viewer device(s) 420. For instance, any content, such as text (e.g., particular words, specific text passages, etc.), images, fields, colors, etc. may correspond to a defined rule written to prevent a viewer (e.g., a customer service representative) from having full access to (e.g., viewing) the content. For example data entry fields or text fields containing private information, such as social security numbers, credit card numbers, etc., may be blocked from view on the viewer devices application window 700b.

Notably, the predefined areas to be limitedly shared may be defined within a code (e.g., software executable/program) used to generate the application window (e.g., web browser code, such as hyper-text markup language, or “html” for a particular web-page as will be understood by those skilled in the art). The code or instructions, therefore, may comprise particular commands that may be interpreted by the corresponding application (e.g., web browser 243) that may correspondingly interface with presenter application sharing software 415 on the presenter device 410 for determining the areas to be limitedly shared. For example, code (e.g., html source code) to display a simple image may comprise a command line such as, e.g.:

<img id=“image_{—}123” src=“http://www.webex.com/IMG_{—}123.JPG”>

In this instance, an image (“img”) may have an identification (“id=”) of “image_{—}123,” and it is located at (“src=”) the URL http://www.webex.com/IMG_123.JPG.” According to the embodiments herein, then, an extended command line for making this image limitedly shared may illustratively comprise:

<img id=“image_123” src=“http://www.webex.com/IMG_123.JPG”
share=“hidden”>

(Those skilled in the art will appreciate that the use of particular terms, such as “share=” and “hidden” are merely examples, and are not meant to be limiting to the embodiments described herein.) Illustratively, then, a field descriptor may be used to define a particular entry/field of an application, such that the application 241 may be able to parse the location of the field (e.g., the image “image_{—}123”) when generating the application window 700a, and may thus confer this location with the presenter application sharing software 415, accordingly. Text, images, data entry fields, etc., may each include such a predefined sharing attribute to describe whether the object is to be fully shared or not fully shared in accordance with one or more embodiments described herein. (Note also that an applet may include similar sharing attributes for individual fields of the applet window, or may have a universal sharing attribute for the entire applet window as either fully shared or limitedly shared as described herein.)

Illustratively, assume that images 720 and 760 and text fields 725 and 755 are to be limitedly shared with viewers (e.g., hidden from viewers), and that entry field 735 and submit button 770 are also to be limitedly shared (e.g., accept “presenter-only” control/input). Accordingly, image 710, text 725, and entry field 730 are to be fully shared (text 740, image 745, and entry field 750 are addressed below). When generating the application window 700a, therefore, the presenter device 410 may determine (e.g., through collaboration between the application 241/243 and the presenter application sharing software 415) the location of the areas to be limitedly shared, and may limit their sharing accordingly. For instance, the presenter device 410 may prevent images or text from being viewed on the one or more viewer devices (e.g., 720, 725, 735, 755, and 760), such as shown in viewer's perspective 700b. Also, the presenter device may restrict viewer control and input from the one or more predefined areas (e.g., 735 and 770).

Note that to prevent the areas (text, images, etc.) from being viewed, various techniques may be used. For instance, the limitedly shared areas may be blocked out (e.g., image 720b), hashed (e.g., text 725), or otherwise obscured from view (e.g., not shown, such as text 755 and 760). How the areas are limitedly shared may be pre-defined within the code of the application, or may be a default/setting of presenter application sharing software. Illustratively, once presenter application sharing software 415 determines the location of the limitedly shared areas, the image corresponding to that area may be replaced by a different image (e.g., blacked out boxes, other colors, other images such as “content unavailable/hidden,” hashed text such as asterisks “* * * * * ” or bullets or circles, etc.) prior to transmitting/sharing the application window 700a with the one or more viewer devices. Also, to restrict viewer control and input from the one or more predefined areas, the presenter application sharing software 415 may receive either control or input from a viewer device via the application sharing session, and may correspondingly reject that control or input in those areas. (Alternatively, assuming trusted relationships, presenter application sharing software 415 may relay the locations/instructions of limitedly shared areas, and viewer application sharing software 425 may perform the obstructing and/or input/control restricting.)

In accordance with one or more aspects of the embodiments described herein, certain limitedly shared areas of the application windows may be “grayed out” on either the presenter device (limitedly shared areas) or the viewer device (areas to accept presenter-only control and/or input). For instance, as defined or configured (e.g., by the corresponding code or as a default, such as all areas or all of a certain type of area), the limitedly shared areas may be shown on either device display 700 with an indication of their limitedly shared status, accordingly.

“Graying out,” such that a user viewing the application windows 700 will see a distinctly different colorization of the limitedly shared areas, describes displaying an area with a light shade of gray, e.g., overlaid upon the window, or having grayscale colors replace full colors within the window. In this manner, the grayed out areas window may appear lighter or darker than the rest of the application window. Notably, in this sense, and as may be appreciated by those skilled in the art, the use of the phase “graying out” need not imply the color gray, a grayscale view, or any other action associated with the color gray. Instead, its use implies any technique, known or otherwise, that may be used to change the appearance of an area within an application window, e.g., lighter or darker, such that a presenter/viewer may be made aware of the fact that these changed appearance areas (e.g., limitedly shared areas) are different from non-changed appearance windows (e.g., fully shared portions/areas of the application window).

Graying out on the viewer device (window 700b) may be performed in a similar manner as described above to hide the contents, such as by not replacing the image corresponding to a limitedly shared area, but instead merely altering the image to appear grayed out (e.g., 735b and 770b). On the presented device (window 700a), however, an illustrative technique that may be used to gray out the limitedly shared areas is to cover those areas with a semi-transparent window. Illustratively, the semi-transparent window may be configured with one-half transparency (e.g., a “half transparent window style”) as may be appreciated by those skilled in the art. For instance, the semi-transparent window may have a gray coloring with a transparency level between 1% and 99%, preferably between 25% and 75% to allow the presenter to still see the limitedly shared areas, yet still distinguish those areas from the rest of the viewable shared application window 700a. (Other coloring may also be used and made transparent, such as white, black, yellow, green, etc.) In this embodiment, controls from the presenter may be passed through the covering semi-transparent window and input to the underlying limitedly shared areas, (thus appearing as though the semi-transparent windows are not separate windows, but merely a change in coloring of the underlying limitedly shared areas).

In accordance with one or more further aspects of the embodiments described herein, the location of the limitedly shared areas may be variable, in that their positions may change with respect to the shared application window. Accordingly, the presenter application sharing software 415 may be configured to determine the variable location, such as based on a scrolling image of the window (e.g., with scroll bar 785), such that as the application window is scrolled (as illustrated by the dashed lines in FIGS. 7A and 7B), the position of limitedly shared areas have changed with respect to the shared application window 700. These areas may accordingly be limitedly shared based on the variable locations as determined by the presenter application sharing software 415 (e.g., in conjunction with application 241/243).

In addition, in accordance with one or more embodiments described herein, limitedly shares areas of an application window need not only be predefined by a designer or administrator of a corresponding application. In particular, predefinition of the areas may be a dynamic process, where the presenter/user may configure the limitedly shared areas. In one aspect, that is, the limitedly shared areas may be defined by user input to the presenter device detailing the area, e.g., with user input comprising outlining the area within the application window. For instance, assume that a presenter wishes to not share (or otherwise limitedly share) text 740, image 745, and entry field 750. The presenter may outline the area 780 (e.g., by “clicking and dragging” a surrounding box), and may configure this area to be hidden from the viewer device(s) 420. As such, the area (780b) may be shown as a hidden area on the viewer devices application window 700b. Alternatively, each object (e.g., text, image, entry fields, etc.) may be configurable by the presenter (e.g., by “right-clicking” the object) to fully share or limitedly share particular areas/objects of the application window 700a, such as where a presenter may wish to limit access to certain objects that may not have been limited by the designer/administrator of the application. Thus, “predefined areas” need not imply being defined prior to generation of the application window 700a, but merely implies being defined prior to determining the location of the limitedly shared areas.

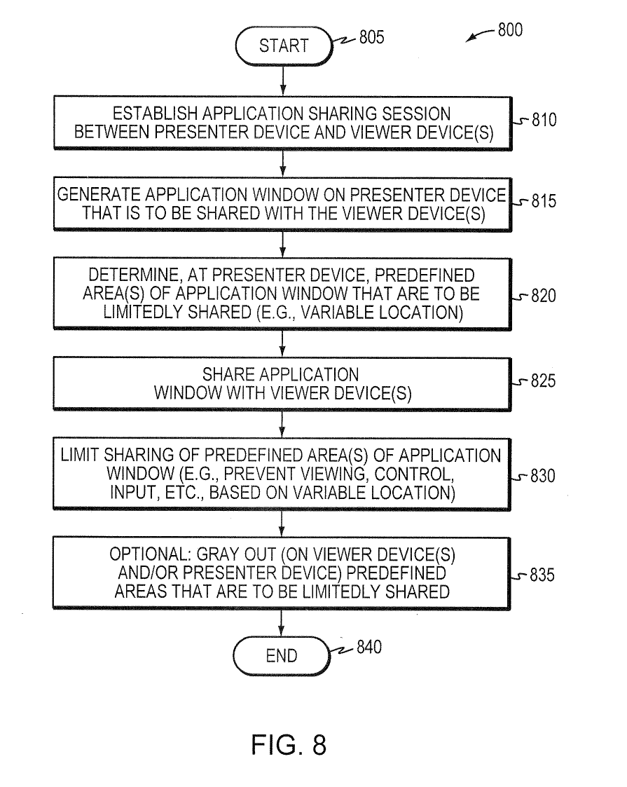

FIG. 8 illustrates an example procedure for limitedly sharing areas of application windows on a presenter device in an application sharing session in a computer network in accordance with one or more embodiments described herein. The procedure 800 starts at step 805, and continues to step 810, where an application sharing session is established between a presenter device and one or more viewer devices, e.g., as described above. Also, in step 815, a particular application window 700a (e.g., a web-page and/or applet) is generated on the presenter device that is to be shared (e.g., is selected for sharing) with the viewer devices.

In step 820, the presenter device (e.g., presenter application sharing software 415 or 416) determines one or more predefined areas of the shared application window 700a that are to be limitedly shared. For example, as described above, one or more text strings, entry fields, buttons, images, etc., may be limitedly shared through predefined rules. For instance, code of an associated application window (e.g., web-page) may define the areas, or the user (presenter) may define the areas. Notably, the predefined areas may have a variable location as mentioned above (such as the simple scrolling window example), and as such, step 820 may dynamically determine the location of the predefined areas accordingly.

The application window may be shared with the viewer devices in step 825, such as via the established application sharing session (e.g., with or without a server 300/440). In accordance with one or more embodiments described herein, the determined areas of the application window in step 820 may be limitedly shared in step 830. For example, the areas may be hidden or obscured from view on viewer devices, or controls/input from the viewer devices may be restricted on the presenter device for those particular areas. Optionally, the predefined area(s) may be grayed out, such as those areas to be limitedly shared on the presenter device, or those areas out of the viewer's control on the viewer device, as mentioned above.

The procedure 800 ends in step 840, such as when the application sharing session is complete, or when the presenter is otherwise no longer sharing the application. Notably, any changes to the generated application window in step 815 (such as where the window is scrolled and the variable location of the limitedly shared area(s) have changed in step 820), the procedure may return to corresponding steps to regenerate and/or redetermine those limitedly shared application windows, accordingly.

Advantageously, the novel techniques described herein limitedly share areas of application windows on a presenter device in an application sharing session in a computer network. By limitedly sharing areas of application windows, the novel techniques allow for secure information on a presenter device to be kept secure during an application sharing session, as well as preventing a viewer from controlling or supplying inputs to areas under presenter-only control. In particular, the techniques allow for co-browsing rules to be defined that prevent a viewer (e.g., a customer service representative) from taking certain actions or viewing certain data on a web-page while co-browsing webpages with the presenter (e.g., customer). In addition, the techniques allow for these features to function on application sharing sessions that are not proxy-based, which are limited in capability (e.g., displaying applets, e.g., Java® or Flash® applets).

While there have been shown and described illustrative embodiments that limitedly share areas of application windows on a presenter device in an application sharing session in a computer network, it is to be understood that various other adaptations and modifications may be made within the spirit and scope of the present invention. For example, the embodiments have been shown and described herein for use with web browser-based applications (“co-browsing”). However, the embodiments of the invention in their broader sense are not so limited, and may, in fact, be used with other applications/sessions, as may be appreciated by those skilled in the art. Also, while the embodiments described above reference application sharing sessions, other collaborative computing sessions, such as chat sessions, desktop sharing sessions, or other shared sessions where images/text displayed on a presenter device may be limitedly shared with one or more viewer devices, accordingly. Further, while the embodiments described above generally refer to limitedly sharing areas with all of the one or more viewers of an application sharing session, it is also possible and configurable to limit sharing of certain areas to only certain viewers (e.g., certain viewers with permission/access rights, etc.).

Notably, the application sharing techniques described above are merely a representative example of operation, and are not meant to limit the scope of the embodiments described herein. For instance, other techniques may be used to share an application window (or desktop) of a presenter device with one or more viewer devices, and those techniques, where applicable, may be suitable for use with the techniques described herein. For example, while the techniques described above capture images of the application window based on GDI calls made to an operating system within an area defined by a particular application, other techniques may regenerate the application window on the viewer's device.

Those skilled in the art will appreciate, however, that the techniques described above are generally not “proxy-based,” that is, the application sharing is based on a presenter's application windows being shared with one or more viewers, and not the presenter and viewer(s) sharing a commonly executed application on a proxy device within the network. In proxy-based co-browsing, as may be understood by those skilled in the art, content blocking may be performed in a variety of manners, but proxy-based cobrowsing suffers from inefficiencies and incomplete functionality. For instance, certain applets (e.g., Java® or Flash® applets) are not sharable through proxy-based sharing, and thus are not eligible for co-browsing or for the limited sharing aspects described herein. Accordingly, generation of application windows and determination of areas of the application window that are to be limitedly shared is performed at the presenter device, and does not involve co-browsing proxies, accordingly. In addition, as noted above, the non-proxy-based techniques described herein offer additional advantages not available to proxy-based solutions (e.g., applet sharing).

The foregoing description has been directed to specific embodiments of this invention. It will be apparent, however, that other variations and modifications may be made to the described embodiments, with the attainment of some or all of their advantages. For instance, it is expressly contemplated that the components and/or elements described herein can be implemented as software, including a computer-readable medium (e.g., disks/CDs/etc.) having program instructions executing on a computer, hardware, firmware, or a combination thereof. Accordingly this description is to be taken only by way of example and not to otherwise limit the scope of the invention. Therefore, it is the object of the appended claims to cover all such variations and modifications as come within the true spirit and scope of the invention.

What is claimed is:

1. A method, comprising:
establishing an application sharing session between a presenter device and one or more viewer devices;
generating an application window on the presenter device that is to be shared with the one or more viewer devices;
determining, at the presenter device, one or more predefined areas of the application window that are to be limitedly shared;
sharing the application window with the one or more viewer devices; and
limiting sharing of the one or more predefined areas of the application window.

2. The method as in claim 1, wherein limiting sharing comprises:
preventing an image associated with the one or more predefined areas from being viewed on the one or more viewer devices.

3. The method as in claim 1, wherein limiting sharing comprises:
preventing text associated with the one or more predefined areas from being viewed on the one or more viewer devices.

4. The method as in claim 1, wherein limiting sharing comprises:
preventing the one or more predefined areas from being viewed on the one or more viewer devices by one of either blocking out the predefined areas or hashing the predefined areas.

5. The method as in claim 1, further comprising:
defining at least one of the predefined areas as an area containing secure information.

6. The method as in claim 1, further comprising:
defining at least one of the predefined areas as an area to accept presenter-only control and input.

7. The method as in claim 6, wherein the at least one of the predefined areas is selected from a group consisting of: a submit button; an accept button; a buy button; and an agree button.

8. The method as in claim 6, further comprising:
graying out, on the viewer device, the at least one of the predefined areas to accept presenter-only control and input.

9. The method as in claim 1, wherein limiting sharing comprises:
restricting viewer control and input from the one or more predefined areas.

10. The method as in claim 9, wherein restricting comprises:
receiving either control or input from one of the viewer devices at the presenter device via the application sharing session; and
in response, rejecting the corresponding control or input at the presenter device.

11. The method as in claim 1, wherein generating comprises:
generating a web browser application window as the application window.

12. The method as in claim 11, wherein the application sharing session is a co-browsing session.

13. The method as in claim 11, wherein the one or more predefined areas of the application window that are to be limitedly shared are defined within a code used to generate the web browser application window.

14. The method as in claim 1, wherein the one or more predefined areas of the application window that are to be limitedly shared are defined within a code used to generate the application window.

15. The method as in claim 1, further comprising:
defining, at the presenter device, at least one of the predefined areas of the application window that are to be limitedly shared.

16. The method as in claim 15, wherein defining comprises:
defining the at least one of the predefined areas of the application window that are to be limitedly shared by user input to the presenter device detailing the at least one predefined area.

17. The method as in claim 16, further comprising:
detailing the at least one predefined area with user input comprising outlining the at least one predefined area within the application window.

18. The method as in claim 1, further comprising:
determining a variable location of the one or more predefined areas of the application window that are to be limitedly shared;
scrolling the application window; and
limiting sharing of the one or more predefined areas of the application window based on the variable location.

19. The method as in claim 1, further comprising:
graying out, on the presenter device, the one or more predefined areas of the application window that are to be limitedly shared.

20. Software encoded in one or more computer-readable media and when executed operable to:
establish an application sharing session between a presenter device and one or more viewer devices;
generate an application window on the presenter device that is to be shared with the one or more viewer devices;
determine, at the presenter device, one or more predefined areas of the application window that are to be limitedly shared;
share the application window with the one or more viewer devices; and
limit sharing of the one or more predefined areas of the application window.

21. An apparatus, comprising:
means for establishing an application sharing session between a presenter device and one or more viewer devices;
means for generating an application window on the presenter device that is to be shared with the one or more viewer devices;
means for determining, at the presenter device, one or more predefined areas of the application window that are to be limitedly shared;
means for sharing the application window with the one or more viewer devices; and
means for limiting sharing of the one or more predefined areas of the application window.
